(19) United States
(12) Patent Application Publication
(10) Pub. No.: US 2002/0083096 A1
(43) Pub. Date: Jun. 27, 2002

(54) System and method for generating structured documents and files for network delivery

(76) Inventors: Liang Hua Hsu, Plainsboro, NJ (US); Young Francis Day, Plainsboro, NJ (US)

Correspondence Address: Siemens Corporation, Intellectual Property Department, 186 Wood Avenue South, Iselin, NJ, 08830, US

(21) Appl. No.: 09/904,092

(22) Filed: Jul. 12, 2001

Related U.S. Application Data
(60) Provisional application No. 60/259,612, filed on Dec. 18, 2000.

(51) Int. Cl. G06F 17/00

(52) U.S. Cl. 707/513

(57) ABSTRACT

In Web applications, collections of individual document files are stored on a delivery server for delivering to the users. Each document is represented in HTML and identified by a URL. To efficiently transport the documents over the network locally or globally, all documents are relatively small in size. Thus, a well-structured technical manual has become a collection of loosely related small document files. In order to relate documents, hyperlinking is often adopted in an ad-hoc way, no matter whether they are structurally related, semantically related, or even unrelated in any sensible way. A system analyzes the structures of related documents to automatically generate the hierarchical ToC structure that can be used by a set of generic navigation controls to traverse all documents in an efficient way. This technique not only improves the quality and accuracy of the structural aspect of industrial applications on the Web, but also supports the reusability of the navigation control for all applications without any duplicated HTML code in any documents.

This is a non-provisional application of provisional application serial No. 60/259,612 by Liang Hua Hsu et al. filed Dec. 18, 2000.

### BACKGROUND OF THE INVENTION

1. Field of the Invention

The present invention relates to on-line documents, and more particularly to systems and methods of structuring documents.

2. Discussion of the Prior Art

The World Wide Web (Web) has become a viable mechanism for delivering information and communicating with users and customers in many application areas. However, the Web supports only specific document delivery protocols and provides specific document presentation mechanisms. Therefore, within the constraints of these protocols and mechanisms, not all documents can be delivered and presented as desired by an author. For example, the well-structured technical information of industrial applications can be different than the loosely related information of consumer applications. Thus, these different types of documents are handled differently to support the target applications while taking advantage of the convenience of the Web.

Referring to FIG. 1, in Web applications, collections of individual document files are stored on a delivery server, also known as a Web server. Each document may be represented in Hypertext Markup Language (HTML) and identified by a unique identifier, for example, a Universal Resource Locator (URL), together with a host machine name and a document delivery protocol. A user invokes a Web browser 102 such as Internet Explorer or Netscape Navigator to download one document at a time 104 from the Web server through its URL. To facilitate cross-referencing between these documents, related documents are hyperlinked together by URLs 106.

The Web can be used for delivering and presenting collections of loosely related documents. The Web is also suitable for information retrieval and exchange. In Web applications, to efficiently transport documents over a network, locally or globally, documents are typically small in size, for example, less than 100 pages long. If a document is long, e.g., a magazine, a book, a technical manual, etc., it may be broken into single articles, sections, subsections, etc., small enough for efficient network delivery. Therefore, a well-structured technical manual may become a collection of loosely related document files. In order to relate documents, hyperlinking can be used. However, hyperlinking is applied in an ad-hoc way to relate documents, no matter whether they are structurally related, semantically related, or even unrelated. Thus, hyperlinking quality is subject to variation.

Referring to FIG. 2, in order to support engineering and manufacturing applications, technical documents are well-structured and relevant engineering data are cross-referenced precisely according to the guidelines or standards of a specific company or industry. In order to address these structural issues, a three-frame approach is typically adopted by the Web applications. That is, in addition to the main document frame 104, there is a table of contents (ToC) frame 202, and a top frame (or navigation frame) with control buttons 204 for controlling the navigation of the manual structure.

Although the three-frame approach solves the presentation problems, it does not address authoring issues. For example, the three-frame approach has been applied in an ad-hoc way, and mostly is implemented with HTML files directly. Thus, redundant ToC and navigation information is often hard-coded in HTML and is duplicated in all documents. A manual of 100 documents, for example, can expand into a collection of 300 HTML files, including, 100 original documents, 100 ToC files, and 100 navigation control files. The three-frame approach increases the number of files by a factor of 2, and the document it creates is not reusable. For each manual delivered over the Web, the three-frame approach needs to manually create or automatically generate 2 additional types of files.

Therefore, a need exists for a system and method of analyzing the structure of related documents to automatically generate a ToC structure in a ToC frame that can be used by a set of generic navigation controls in the navigation frame. This technique not only improves the quality and accuracy of the structural aspect of industrial applications on the Web, but also supports the reusability of the navigation control for all applications without any duplicated HTML code in any documents.

### SUMMARY OF THE INVENTION

According to an embodiment of the present invention, a system is provided for processing a plurality of related sub-documents to produce information associated with an encompassing document structure. The system includes a source of control information for determining content structure of an encompassing document, and a first document processor for deriving internal structure information by analyzing the internal structure of each of said plurality of related sub-documents in response to said control information. The system further includes a second document processor for deriving external structure information by analyzing the structural relationship between said plurality of related sub-documents in response to said control information, and a data generator for generating a table of contents using said internal structure information and said external structure information.

The data generator further generates menu icons representing navigation controls supporting User navigation through said encompassing document structure using table of contents information. The navigation controls comprise one or more of, (a) controls for navigating between sub-documents, (b) controls for navigating within an individual sub-document, (c) controls for navigating forward or backward between sub-documents, and (d) controls for navigating upward and downward within an individual sub-document.

The sub-documents comprise one or more of, (a) an SGML document, (b) an XML document, (c) an HTML document (d) a document encoded in a language incorporating distinct content attributes and presentation attributes, and (e) a multimedia file.

The first document processor derives said internal structure information by identifying at least one of, (a) objects within a document and (b) divisions between objects. The objects within a document comprise heading objects including at least one of, headings, footers, headers, figure titles and table titles, and non-heading objects including at least one of, paragraphs, lists tables and graphics. The divisions between objects are identified based on at least one of, (i) a horizontal line, (ii) a larger than typical vertical spacing between text lines, (iii) heading marks, (iv) text properties and (v) special objects. The control information identifies different objects.

The source of control information comprises an SGML document.

The second document processor derives said external structure information by using said control information in hierarchically ordering said plurality of related sub-documents to conform to a hierarchical section numbering system.

According to an embodiment of the present invention, a system is provided for processing a plurality of related sub-documents to produce information associated with an encompassing document structure. The system includes a source of control information for determining content structure of an encompassing document. The system further includes a first document processor for deriving internal structure information by analyzing the internal structure of each of said plurality of related sub-documents in response to said control information, and a second document processor for compiling encompassing document structure information by integrating related sub-document structure information into composite structure information. The system includes a data generator for generating a table of contents using encompassing document structure information.

The second document processor compiles encompassing document structure information into a hierarchical structure. The data generator further generates navigation information supporting User navigation through said encompassing document structure using table of contents information.

A User interface system is provided according to an embodiment of the present invention, supporting processing of a plurality of related sub-documents to produce information associated with an encompassing document structure. The User interface system includes a menu generator for generating, one or more menus permitting User selection of input sub-documents to be processed to create an encompassing document structure, and an icon permitting User initiation of processing of related sub-document structure information to create an encompassing document structure derived by integrating related sub-document structure information into composite structure information. The User interface system includes menu icons representing navigation controls supporting User navigation through said encompassing document structure using said composite structure information.

The User interface menu functions are incorporated into a web browser.

According to an embodiment of the present invention, a system is provided for processing a plurality of related sub-documents to produce information associated with an encompassing document structure. The system includes a source of control information for determining content structure of an encompassing document. The system further includes a first document processor for deriving internal structure information by parsing the internal structure of each of said plurality of related sub-documents to identify structural object elements in response to said control information, and a second document processor for compiling encompassing document structure information by integrating related sub-document structure information, derived using said identified object elements, into composite structure information. The system includes a processor for generating a navigation menu based on said composite structure information.

The navigation menu comprises a table of contents linked to associated content via a database.

According to an embodiment of the present invention, a program storage device is provided readable by machine, tangibly embodying a program of instructions executable by the machine to perform method steps for determining a structure for an electronic document. The method includes identifying a plurality of divisions between a plurality of document objects, identifying a plurality of heading objects, determining a plurality of relationships between the objects, wherein the relationships define an internal structure, and updating the internal structure upon determining a new relationship. The method includes identifying a plurality of sections within each document, and formatting the documents in a linear sequence. The method further includes providing a plurality of section headings in a linear sequence, and providing a plurality of standardized controls.

### BRIEF DESCRIPTION OF THE DRAWINGS

Preferred embodiments of the present invention will be described below in more detail, with reference to the accompanying drawings:

FIG. 1 is an illustration of a system of rendering documents over the Internet;

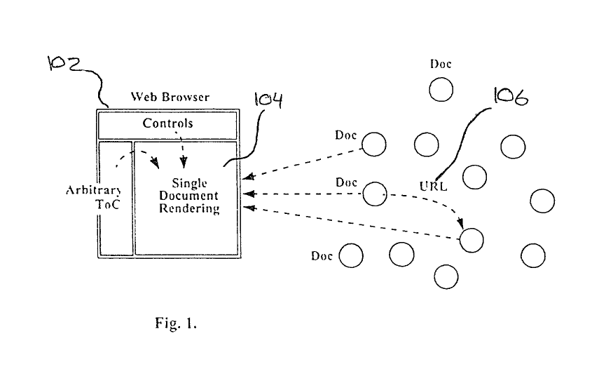

FIG. 2 is an illustration of a system of rendering structured documents over the Internet;

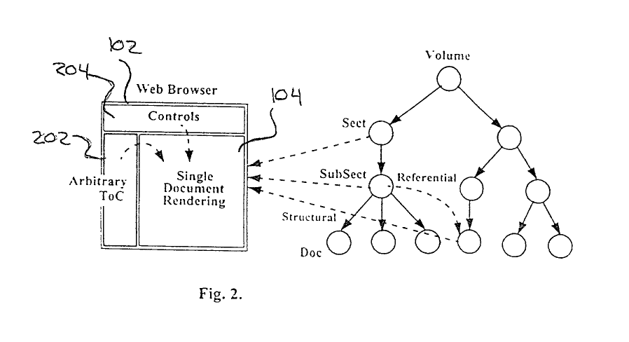

FIG. 3 is an illustration of a method of creating a structured document according to an embodiment of the present invention;

FIG. 4 is an illustration of a method of structuring the internal components of a document according to an embodiment of the present invention;

FIG. 5 shows a collection of primitive document objects according to an embodiment of the present invention;

FIG. 6 shows a collection of internal document objects according to an embodiment of the present invention;

FIG. 7 shows a collection of external document objects according to an embodiment of the present invention;

FIG. 8 shows an example of a table of contents specification according to an embodiment of the present invention; and

FIG. 9 is an illustrative view of a User interface system according to an embodiment of the present invention.

### DETAILED DESCRIPTION OF PREFERRED EMBODIMENTS

According to an embodiment of the present invention, a Structured Documentation Process (SDP) is proposed. The SDP can be applied to analyze a collection of related technical documents, extract structural information, determine structural relationships, and automatically generate a table of contents (ToC). The method provides a reproducible ToC for a given document, thus enhancing the usability of the contents of the document.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

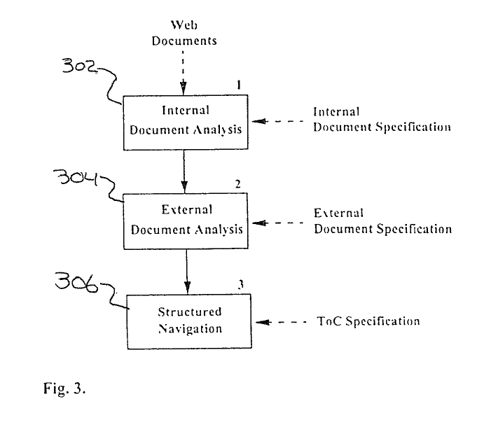

The structured documentation process includes: internal document analysis, external document analysis, and structured navigation, as shown in FIG. 3. At Block 302, syntactical analysis is performed on the internal structure of each individual document by parsing its content, breaking the content into objects, and determining the relationships between objects. A specification is provided by the user to specify the rules for performing the syntactical analysis within individual documents. At Block 304, external view of a set of related documents are compared to determine their positions in a hierarchical structure. A specification is also provided by the user to specify the relationships between documents externally. At Block 306, the document analysis information is used to generate the ToC of the set of documents, which is then applied to support navigation in a general way.

Internal Document Analysis

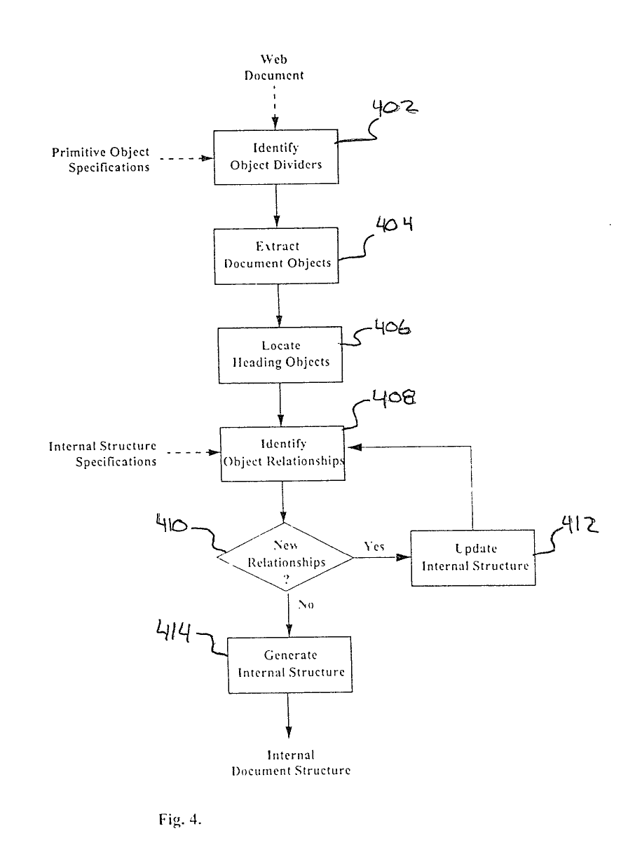

The purpose of internal document analysis is to capture the internal structure of a single document. In this invention, an internal document structuring method is proposed, as shown in FIG. 4. The method includes dividing a document into blocks, wherein each block may be referred to as a document object. The document objects are classified in order to build up the internal structure of a document.

At Block 402, dividers between document objects are identified. In a typical document, potential object dividers can be identified at locations when object types are switched between text, graphics, and tables, or font types, weight, and sizes are switched for text objects, or extra vertical spacing is introduced, or horizontal lines are created, etc. At Block 404, the potential object dividers are collected, and the document is divided into objects accordingly. At Block 406, the document objects are checked to identify heading objects. In a document, heading objects start different segments of document content, e.g., headers, footers, headings, figure titles, table titles, etc.

At Block 408, the heading objects and non-heading objects are analyzed to determine relationships. Typically, a heading and all the objects that follow belong to the same segment, e.g., a section within a document, or in other words, a section of document starts from one specific heading to the next heading. The content of a heading is further analyzed to determine the type of relationship, e.g., regular section, table section, figure section, footnote section, etc., and to determine the hierarchical relationships between different document sections. At Block 408, the method determines whether a new relationship between any two objects is found. At Block 410, an internal document structure is updated upon determining the new relationship. Blocks 408, 410, and 412 continue to iterate until no new relationship is determined. Then, at Block 414, a final internal structure is generated.

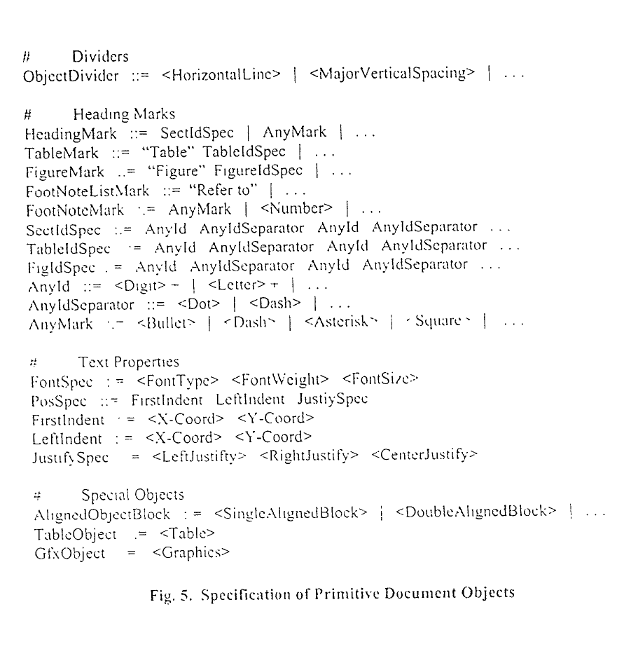

The analysis process is specification-driven, that is, the specification of primitive document objects is explicitly specified by the user to control the analysis mechanism, as shown at Block 402 in FIG. 4. According to an embodiment of the present invention, there are at least four types of primitives useful for identifying document objects, including: dividers, heading marks, text properties, and special objects, as listed in FIG. 5. The specification is based on an Extended Backus Normal Form (EBNF). In particular, terms without brackets are non-terminals, while terms enclosed in brackets are terminals. Terminals are primitive objects in a particular specification. A divider is often a horizontal line or a major vertical spacing that is larger than a pre-defined vertical line spacing. According to an embodiment of the present invention, the spacing is pre-defined, for example, two points more than the font size. A heading mark identifies the beginning of a heading, table title, figure title, or footnote. Each of these heading marks may be followed by an identification specification. Text properties are information about text font and horizontal position. Special objects include, for example, aligned object blocks, table objects, and graphic objects.

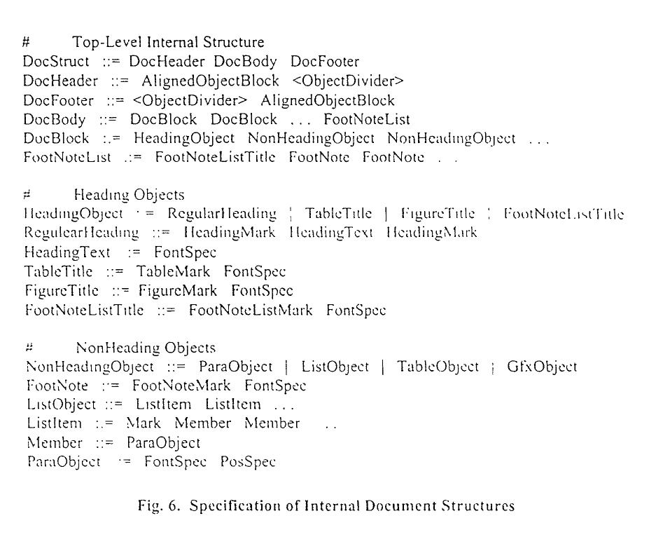

The internal structure of a document is built on top of the primitive objects, as listed in FIG. 6. An internal structure specification is used in Block 408 to determine the relationships between primitive objects. It starts with the top-level structure that includes a header, body, and footer. A document body is further divided into document blocks and footnote lists. A typical document block starts with a heading followed by a sequence of other blocks for paragraphs, lists, tables, or graphics. A footnote list starts with a footnote title followed by a list of footnotes.

There are several types of heading objects, including regular headings, table titles, figure titles, and footnote titles. A regular heading is typically identified by a leading or trailing mark as defined in FIG. 5. Similarly, table titles, figure titles, and footnote titles are also identified by unique heading marks as defined in FIG. 5. There are also several types of non-heading objects, including paragraphs, lists, tables, and graphics. Each type of non-heading objects can also be uniquely identified by the headings preceding them, font specification, position specification, etc.

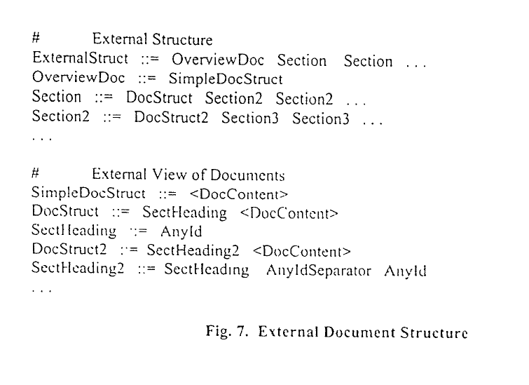

External Document Analysis After the internal document structure has been analyzed, an external analysis is performed to build a higher-level structure on top of the internal structures. A typical external structure specification is listed in FIG. 7. In particular, the structure of a technical manual may be built up by integrating the structures for individual component documents into sections, subsections, etc. A typical document is identified by a section identification, e.g., 1.1.1 Introduction, 1.1.2 System Overview, etc. A section identification can include digits, letters, or any marks, and is typically separated by a separator such as “.” or “-”, as defined in FIG. 5. Thus, section identifications are also used to organize the documents into hierarchical levels (or sections), and at each level, section identifications are used to order the documents in a linear sequence. Several variations can be derived from this approach. For example, depending on the application and the way documents are originally created, section headings can also be identified by the weight and size of the text font, and the hierarchical levels can also be arranged accordingly.

Structured Document Navigation

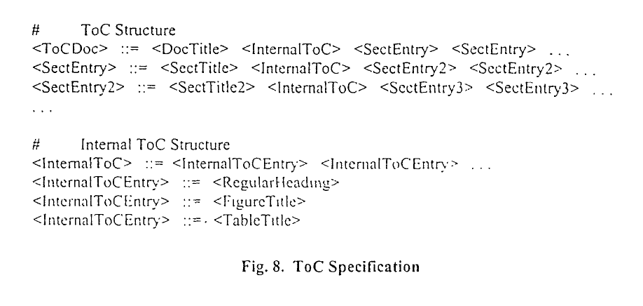

As stated in above, one difficulty in adopting the Web for viewing well-structured technical documents is the inability to navigate through a complex document structure in an efficient way. Existing solutions compose a document according to manually created ad-hoc links, or by automatically generated redundant code in HTML in all documents that link to all other documents in the same structure. By analyzing the internal and external structures of a set of related documents, a hierarchical ToC structure can be automatically generated, and navigation controls can be developed to traverse the structure based on the ToC structure. A typical specification of ToC is listed in FIG. 8. Externally, each document presents itself with a section heading. The document content is provided upon selecting the section heading. To facilitate viewing, for each document, in addition to the section heading, a list of important document entries can also be provided, including subsection headings, figure titles, table titles, etc.

The ToC structure can be automatically generated in any format that is appropriate for viewing and navigation with a Web browser. For example, if an HTML browser is used, a HTML version of the ToC can be generated. On the other hand, if a PDF viewer such as Acrobat Reader is used, a list of PDF bookmarks can be generated as ToC and inserted in the PDF documents. Typical navigation controls include Forward (to the next document within a section or within a manual), Backward (to the previous document within a section or within a manual), Upward (to the section one level higher), Downward (to the first subsection), Home (i.e., the first document in the first section or the first document of the manual), etc. Since the ToC structure is well defined, all navigation controls can be implemented to traverse the ToC structure and view all documents in a general way.

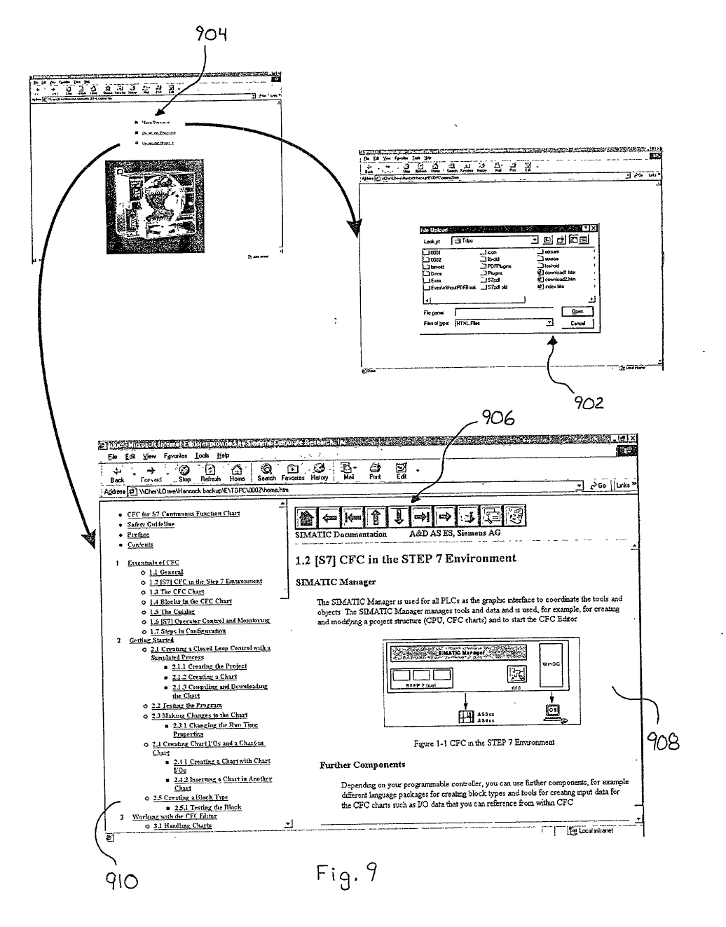

Referring to FIG. 9, showing an illustrative view of a User interface system according to an embodiment of the present invention, a menu generator 902 is provided for generating, at least one menu permitting User selection of input sub-documents to be processed to create an encompassing document structure. The User interface system can also include an icon 904 permitting User initiation of processing of related sub-document structure information to create the encompassing document structure derived by integrating related sub-document structure information into composite structure information. Other icons are contemplated, for example, an icon for initiating the menu generator 902 and for opening a browser window for viewing a document. The User interface system can include menu icons 906 representing navigation controls supporting User navigation through an encompassing document structure using composite structure information. The composite structure of the encompassing document can be shown in a ToC frame 910. The encompassing document can be displayed in, for example, an adjacent frame 908 or separate window. One of ordinary skill in the art would recognize that the User interface shown in FIG. 9 can be modified without departing from the scope of the present invention, for example, by providing a separate window for each of the ToC 910, the navigation controls 906 and the document 908.

Having described embodiments for a system and method of generating a structured document, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A system for processing a plurality of related sub-documents to produce information associated with an encompassing document structure, comprising:
a source of control information for determining content structure of an encompassing document;
a first document processor for deriving internal structure information by analyzing the internal structure of each of said plurality of related sub-documents in response to said control information;
a second document processor for deriving external structure information by analyzing the structural relationship between said plurality of related sub-documents in response to said control information; and
a data generator for generating a table of contents using said internal structure information and said external structure information.

2. The system according to claim 1, wherein said data generator further generates menu icons representing navigation controls supporting User navigation through said encompassing document structure using table of contents information.

3. The system according to claim 2, wherein said navigation controls comprise one or more of, (a) controls for navigating between sub-documents and (b) controls for navigating within an individual sub-document.

4. The system according to claim 2, wherein said navigation controls comprise one or more of, (a) controls for navigating forward or backward between sub-documents and (b) controls for navigating upward and downward within an individual sub-document.

5. The system according to claim 1, wherein said sub-documents comprise one or more of, (a) an SGML document, (b) an XML document, (c) an HTML document (d) a document encoded in a language incorporating distinct content attributes and presentation attributes, and (e) a multimedia file.

6. The system according to claim 1, wherein said first document processor derives said internal structure information by identifying at least one of, (a) objects within a document and (b) divisions between objects.

7. The system according to claim 6, wherein said objects within a document comprise heading objects including at least one of, headings, footers, headers, figure titles and table titles, and non-heading objects including at least one of, paragraphs, lists tables and graphics.

8. The system according to claim 6, wherein said divisions between objects are identified based on at least one of, (i) a horizontal line, (ii) a larger than typical vertical spacing between text lines, (iii) heading marks, (iv) text properties and (v) special objects.

9. The system according to claim 6, wherein said control information identifies different objects.

10. The system according to claim 1, wherein said source of control information comprises an SGML document.

11. The system according to claim 1, wherein said second document processor derives said external structure information by using said control information in hierarchically ordering said plurality of related sub-documents to conform to a hierarchical section numbering system.

12. A system for processing a plurality of related sub-documents to produce information associated with an encompassing document structure, comprising:
a source of control information for determining content structure of an encompassing document;
a first document processor for deriving internal structure information by analyzing the internal structure of each of said plurality of related sub-documents in response to said control information;
a second document processor for compiling encompassing document structure information by integrating related sub-document structure information into composite structure information; and
a data generator for generating a table of contents using encompassing document structure information.

13. The system according to claim 12, wherein said second document processor compiles encompassing document structure information into a hierarchical structure.

14. The system according to claim 12, wherein said data generator further generates navigation information supporting User navigation through said encompassing document structure using table of contents information.

15. A User interface system supporting processing of a plurality of related sub-documents to produce information associated with an encompassing document structure, comprising:
a menu generator for generating, one or more menus permitting User selection of input sub-documents to be processed to create an encompassing document structure;
an icon permitting User initiation of processing of related sub-document structure information to create an encompassing document structure derived by integrating related sub-document structure information into composite structure information; and
menu icons representing navigation controls supporting User navigation through said encompassing document structure using said composite structure information.

16. The User interface system according to claim 15, wherein said User interface menu functions are incorporated into a web browser.

17. A system for processing a plurality of related sub-documents to produce information associated with an encompassing document structure, comprising:
a source of control information for determining content structure of an encompassing document;
a first document processor for deriving internal structure information by parsing the internal structure of each of said plurality of related sub-documents to identify structural object elements in response to said control information;
a second document processor for compiling encompassing document structure information by integrating related sub-document structure information, derived using said identified object elements, into composite structure information; and
a processor for generating a navigation menu based on said composite structure information.

18. The system according to claim 17, wherein said navigation menu comprises a table of contents linked to associated content via a database.

19. A program storage device readable by machine, tangibly embodying a program of instructions executable by the machine to perform method steps for determining a structure for an electronic document, the method steps comprising:
identifying a plurality of divisions between a plurality of document objects;
identifying a plurality of heading objects;
determining a plurality of relationships between the objects, wherein the relationships define an internal structure;
updating the internal structure upon determining a new relationship;
identifying a plurality of sections within each document;
formatting the documents in a linear sequence;
providing a plurality of section headings in a linear sequence; and
providing a plurality of standardized controls.
